(19) United States
(12) Patent Application Publication
(10) Pub. No.: US 2013/0169808 A1
(43) Pub. Date: Jul. 4, 2013

(54) METHOD FOR CALIBRATING ALIGNMENT ERRORS OF AN EARTH OBSERVATION SYSTEM MAKING USE OF SYMMETRICAL EXPOSURES

(71) Applicant: Jean-Marc Delvit, Toulouse (FR)

(72) Inventor: Jean-Marc Delvit, Toulouse (FR)

(21) Appl. No.: 13/733,392

(22) Filed: Jan. 3, 2013

(30) Foreign Application Priority Data
Jan. 3, 2012 (FR) 1250041

(51) Int. Cl. H04N 17/00

(52) U.S. Cl. CPC H04N 17/002
USPC 348/144

(57) ABSTRACT

According to a first aspect, the invention relates to a method for calibrating alignment errors of a sight mark of an on-board imaging system inside an observation satellite, wherein a reference image of a scene is compared with a secondary image of the scene acquired by the imaging system,
characterized in that the reference image and the secondary image consist of exposures of the scene acquired by the imaging system, the direction of motion of the observation satellite during the exposure of the secondary image being opposite to the direction of motion of the observation satellite during the exposure of the reference image.

### FIELD OF THE INVENTION

The field of the invention is that of observation satellites, and more particularly that of calibration of the on-board imaging systems in such satellites.

More precisely still, the invention relates to in-flight calibration of the alignment errors of an earth observation system.

### BACKGROUND OF THE INVENTION

In-orbit delivery of an observation satellite starts after checking the correct operation of the satellite and lasts a few months. This delivery is implemented in order to check the conformity of the system with specifications and allow the distribution and marketing of images with the best possible localization.

The assessment of geometric performance is also monitored throughout the life of the satellite, in order to be able to identify possible changes or anomalies.

Geometric calibration is the first objective of the geometric in-orbit delivery. Its aim is to supply ground processing with certain of the geometric parameters involved in geometric modeling and processing. These parameters were previously measured on the ground, but certain of them may have changed following launch; others were measurable only with insufficient accuracy. These parameters include the orientation of the sight mark.

Thus during in-flight geometric calibration, the aim is to accomplish calibration of the sight mark, or calibration of the alignment errors, consisting of determining the absolute orientation of the sight mark.

As described in pages 137-141 of the work “Imagerie Spatiale, des principes d'acquisition au traitement des images optiques pour l'observation de la Terre [Imagery from Space, from acquisition principles to optical image processing for Earth observation]”, published by Cépaduès publishers (ISBN: 978.2.85428.844.5), geometric calibration of alignment errors is done at present mainly by using sites that are exactly known geometrically, both planimetrically and altimetrically. These sites are of different types (geometric images and models, control points, 3D models . . . ), and have different levels of accuracy.

These sites consist of two main families, one enabling calibration of the alignment errors and measuring the localization performance (control point database), the other enabling fine geometry by means of dynamic and static analysis allowing fine analysis of the attitude residues and cartography of the different focal points (geometric supersite). Besides accuracy problems, there is also the problem of aging of these references, particularly when this reference is an image (supersite), or accompanied by a thumbnail image (control point).

Generally, a technique is sought for geometrically calibrating an earth observation system which would avoid these constraints.

### DISCLOSURE OF THE INVENTION

The invention has the objective of responding to these needs, and proposes to this end, according to a first aspect, a method for calibrating alignment errors in roll and in pitch of a sight mark of an on-board imaging system within an observation satellite, wherein a reference image of a scene is compared with a secondary image of the scene acquired by the imaging system, characterized in that the reference image and the secondary image consist of images of the scene acquired by the imaging system, the direction of motion of the observation satellite during imaging of the secondary image being opposite to the direction of motion of the observation satellite during the imaging of the reference image.

This method thus makes it possible to dispense with control points for calibrating the alignment errors of an earth observation system.

Certain preferred, but non-limiting aspects of this method are the following:
the comparison of the reference image and the secondary image employs a correlation of said images;
it also includes the averaging of a line and the averaging of a column of the matrix obtained by correlation of the reference image and the secondary image to assess respectively the pitch error and the roll error;
the estimation of pitch and roll error is carried out by spatial triangulation;
the reference image and the secondary image are acquired during one and the same pass of the observation satellite over the scene;
it includes, prior to the comparison of the reference image with the secondary image, a step consisting of co-locating said images with the aim of projecting the secondary image into the reference image to make them quasi-superposable;
the method being implemented for a plurality of scenes, average alignment errors are estimated by averaging, on the one hand, the pitch error estimates calculated for each scene of the plurality of scenes, and on the other hand the roll error estimates calculated for each scene of the plurality of scenes;
the standard deviation of the pitch error estimates and the standard deviation of the roll error estimates are calculated.

According to a second aspect, the invention relates to a computer program product including a set of instructions which, when they are executed by a data processing unit cause said unit to execute the steps of the method according to the first aspect of the invention.

According to a third aspect, the invention relates to an imaging system designed to be carried on board an observation satellite, including a detection bar consisting of a plurality of detectors and a computer program according to the second aspect of the invention which, when it is implemented, makes it possible to accomplish the calibration of the alignment errors in roll and in pitch of the imaging system.

### BRIEF DESCRIPTION OF THE DRAWINGS

Other aspects, objectives and advantages of the present invention will be better revealed upon reading the following detailed description of preferred embodiments thereof, given by way of a non-limiting example and made with reference to the appended drawings wherein:

FIG. 1 illustrates the exposures of a reference image and a secondary image of one and the same scene in conformity with the invention;

FIG. 2 illustrates the scheme for measuring the average line and column offsets for reaching the roll and pitch errors;

FIG. 3 is a schematic diagram illustrating the different steps of a possible embodiment of the method according to the first aspect of the invention.

### DETAILED DESCRIPTION OF THE INVENTION

Generally, the invention proposes, according to a first aspect, a method for calibrating the alignment errors of a sight mark of an on-board imaging system carried inside an observation satellite, which allows control points to be dispensed with based on two symmetrical acquisitions (not necessarily single-pass) of one and the same scene. The principal advantage of this type of acquisition is to make symmetrical the effects on the ground due to the errors in roll and in pitch.

The invention thus proposes to compare a reference image of a scene with a secondary image of the same scene acquired by the imaging system. The reference image and the secondary image consist of exposures of the scene acquired by the imaging system, the direction of motion of the observation satellite during the exposure of the secondary image being opposite to the direction of motion of the observation satellite during the exposure of the reference image.

Thus, if a positive roll effect for the first exposure (reference image) results in an easterly offset, the same positive roll effect on the second exposure (secondary image) results in a westerly offset. Likewise for north/south pitch. By measuring the offset of the two exposures on the ground, an observable is obtained that correlates to double the alignment errors (in roll and in pitch).

Launched in December 2011, the earth observation satellite PLEIADES exhibits the advantage of being agile in the sense that it can rapidly change its sight direction by rocking to either side of the orbital plane or from front to rear. This maneuver capability makes it possible to create image mosaics with a widened field or to compose views of one and the same scene taken at different angles so as for example to reconstruct a scene in 3D.

An agile satellite such as the PLEIADES satellite can be maneuvered in yaw within the scope of the invention to perform the acquisition of the image pair consisting of the reference image and the secondary image. More precisely, the reference image can be acquired conventionally using the satellite's progression, and the secondary image can be acquired after a 180° yaw maneuver, the detection bar of the imaging system thus turned allowing the same scene to be re-imaged with the help of a pitch maneuver. The pitch maneuver then “opposes” the natural progression of the satellite.

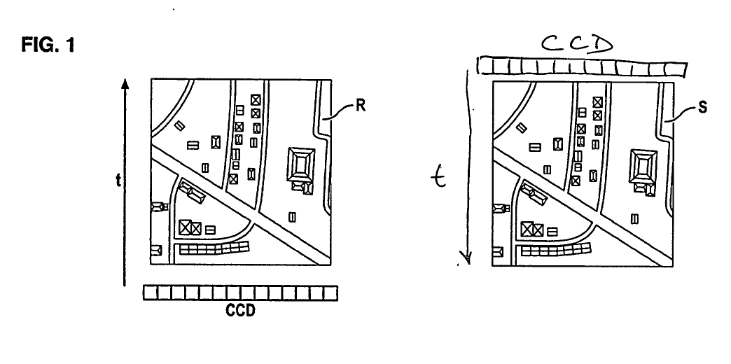

Shown in FIG. 1 are the “symmetrical” exposures of a reference image R and of a secondary image S of one and the same scene in conformity with the invention.

In this FIG. 1, the label CCD illustrates the position of the detection bar of the imaging system of the observation satellite. This bar, typically of the CCD (Charge-Coupled Device, meaning a device employing charge transfers) type, includes a plurality of photosensitive sensors arranged in a row, for example on the order of 4,000 to 6,000 sensors per row. As for the label t, it illustrates the motion of the satellite over time. It will be observed that the invention is not limited to scanning sensors of the “push-broom” type, but also extends to matrix type sensors.

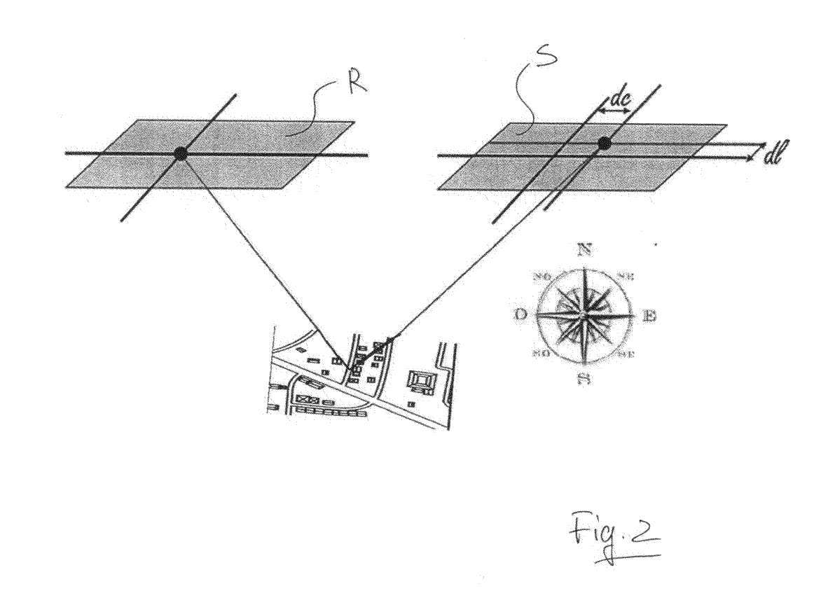

Shown in FIG. 2 is the scheme for measuring average line and column offsets between the reference image and the secondary image to arrive at the pitch and roll errors. The line offset dl is characteristic of double the pitch error, while the column offset dc is characteristic of double the roll error.

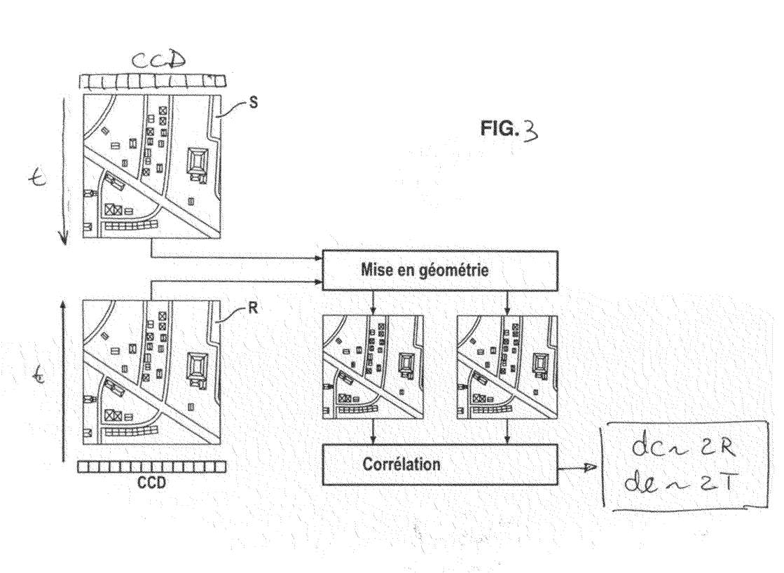

FIG. 3 is a schematic diagram illustrating the different steps of a possible embodiment of the method according to the first aspect of the invention.

According to the first step called “geometry adjustment,” a reference product and a secondary product are selected within the image pair. The geometric models of the reference image and of the secondary image are then used in order to inject into the images all the knowledge delivered by the system (digital terrain model, attitudes, cartography of the existing focal plane . . . ). The two images are then quasi-superposable. The only differences arise from lack of knowledge of the focal plane and from residual attitude errors (not corrected by the Attitude and Orbit Control System ROCS).

This “geometry adjustment” step thus consists of projecting the first image of the pair onto the second. More precisely, a transformation called “co-localization” is employed to put into correspondence all the line, column positions of the first image with the line and column positions of the second image. For this purpose, the direct localization model of the first image is used (using all the information contained in the auxiliary data of the product) in order to obtain information on the position of that image on the ground. This ground information and the inverse localization model of the second image are then used.

According to a second step, the comparison, by correlation for example, of the secondary image and the reference image is performed to estimate the pitch and roll errors.

It will be noted that the invention is not limited to the implementation of a correlation, but extends to any other technique for measuring offsets between images.

The average offset in line and in column is then calculated to estimate the pitch error and the roll error. The average line offset corresponds in fact to twice the pitch error and the average column offset corresponds to twice the roll error.

Thus, averaging a line and averaging a column of the matrix obtained by the correlation of the reference image and the secondary image make it possible to estimate the pitch error and the roll error, respectively.

According to one possible embodiment, the estimation of errors in pitch and in roll is carried out by spatial triangulation.

This second step is advantageously repeated several times on a plurality of scenes (for example, thirty or so scenes as is the case with conventional geometric calibration techniques) and therefore several reference image/secondary image pairs. Average alignment errors are then estimated by averaging, on the one hand, the roll error estimates calculated for each scene of the plurality of scenes. The standard deviation of the pitch error estimates and the standard deviation of the roll error estimates are also advantageously calculated to supply an estimate of the localization performance.

It will be understood that the main advantage of the method according to the first aspect of the invention is that is allows the performance of an autonomous calibration of the alignment errors not requiring supersites (which also makes it possible to avoid the constraints of creating, operating and maintaining supersites) or control points (GPS, maps, etc.) either.

This method also makes it possible to dispense with a specific localization (connected to supersites). It is then possible to calibrate the alignment errors on sites at different latitudes, which allows the possible thermo-elastic changes in these errors to be monitored, and to use for routine monitoring orbits with a light workload. It is also possible to use a great number of sites and therefore to improve the accuracy of the geometric calibration.

It will be understood that the invention is not limited to a method according to its first aspect, but also extends according to a second aspect to a computer program product including a set of instructions which, when they are executed on a data processing unit, cause said unit to execute the steps of the method according to the first aspect of the invention. The invention extends further to an imaging system designed to be carried on board an observation satellite, which system includes a detection bar consisting of a plurality of detectors and a computer program product according to the second aspect of the invention which, when it is implemented, allows the performance of a calibration of the imaging system.

1. A method for calibrating alignment errors in roll and in pitch of a sight mark of an on-board imaging system inside an observation satellite, wherein a reference image of a scene is compared with a secondary image of the scene acquired by the imaging system,
wherein the reference image and the secondary image consist of exposures of the scene acquired by the imaging system, the direction of motion of the observation satellite during the exposure of the secondary image being opposite to the direction of motion of the observation satellite during the exposure of the reference image.

2. The method according to claim 1, wherein the comparison of the reference image and the secondary image employs a correlation of said images.

3. The method according to claim 2, also including averaging of a line and averaging of a column of the matrix obtained by correlation of the reference image and the secondary image to estimate the pitch error and the roll error, respectively.

4. The method according to claim 3, wherein the estimation of the errors in pitch and in roll is performed by spatial triangulation.

5. The method according to claim 1, wherein the reference image and the secondary image are acquired during one and the same pass of the observation satellite over the scene.

6. The method according to claim 1, including, prior to the comparison of the reference image and the secondary image, a step consisting of co-localizing said images with the aim of projecting the secondary image into the reference image to make them quasi-superposable.

7. The method according to claim 1, wherein it is carried out for a plurality of scenes and in that the average alignment error is estimated by averaging, on the one hand, the pitch error estimates calculated for each scene of the plurality of scenes, and on the other hand the roll error estimates calculated for each scene of the plurality of scenes.

8. The method according to claim 1, wherein the standard deviation of the pitch error estimates and the standard deviation of the roll error estimates are calculated.

9. A computer program product including a set of instructions which, when they are executed on a data processing unit, cause said unit to execute the steps of the method according to any one of claim 1.

10. An imaging system designed to be carried on board an observation satellite, including a detection bar consisting of a plurality of detectors and a computer program according to claim 9 which, when it is implemented, allows the performance of a calibration of the alignment errors in roll and in pitch of the sight mark of the imaging system.

11. A computer program product including a set of instructions which, when they are executed on a data processing unit, cause said unit to execute the steps of the method according to any one of claim 2.

12. A computer program product including a set of instructions which, when they are executed on a data processing unit, cause said unit to execute the steps of the method according to any one of claim 3.

13. A computer program product including a set of instructions which, when they are executed on a data processing unit, cause said unit to execute the steps of the method according to any one of claim 4.

14. A computer program product including a set of instructions which, when they are executed on a data processing unit, cause said unit to execute the steps of the method according to any one of claim 5.

15. A computer program product including a set of instructions which, when they are executed on a data processing unit, cause said unit to execute the steps of the method according to any one of claim 6.

16. An imaging system designed to be carried on board an observation satellite, including a detection bar consisting of a plurality of detectors and a computer program according to claim 11 which, when it is implemented, allows the performance of a calibration of the alignment errors in roll and in pitch of the sight mark of the imaging system.

17. An imaging system designed to be carried on board an observation satellite, including a detection bar consisting of a plurality of detectors and a computer program according to claim 12 which, when it is implemented, allows the performance of a calibration of the alignment errors in roll and in pitch of the sight mark of the imaging system.

18. An imaging system designed to be carried on board an observation satellite, including a detection bar consisting of a plurality of detectors and a computer program according to claim 13 which, when it is implemented, allows the performance of a calibration of the alignment errors in roll and in pitch of the sight mark of the imaging system.

19. An imaging system designed to be carried on board an observation satellite, including a detection bar consisting of a plurality of detectors and a computer program according to claim 14 which, when it is implemented, allows the performance of a calibration of the alignment errors in roll and in pitch of the sight mark of the imaging system.

20. An imaging system designed to be carried on board an observation satellite, including a detection bar consisting of a plurality of detectors and a computer program according to claim 15 which, when it is implemented, allows the performance of a calibration of the alignment errors in roll and in pitch of the sight mark of the imaging system.
